(19) United States
(12) Patent Application Publication
(10) Pub. No.: US 2025/0003132 A1
(43) Pub. Date: Jan. 2, 2025

(54) HOUSEHOLD APPLIANCE WITH A SENSOR DEVICE

(71) Applicant: emz-Hanauer GmbH & Co. KGaA, Nabburg (DE)

(72) Inventors: Thomas Schmid, Eslarn (DE); Martin Brabec, Nabburg (DE); Lukas Schade, Nabburg (DE)

(21) Appl. No.: 18/734,066

(22) Filed: Jun. 5, 2024

(30) Foreign Application Priority Data
Jun. 30, 2023 (DE) 102023117402.9

(51) Int. Cl. D06F 34/22; D06F 103/20; D06F 103/66; H04B 10/43

(52) U.S. Cl. CPC D06F 34/22; H04B 10/43; D06F 2103/20; D06F 2103/66

(57) ABSTRACT

A household appliance with a sensor device, wherein the sensor device is designed and intended to obtain information about the chemical and physical properties of a liquid on the basis of the (spectral) measurement data signature. For example, the turbidity of a liquid can be determined with the aid of the measurement data signature, wherein the sensor device has a light transmitter side and a light receiver side, wherein light can be transmitted from the light transmitter side to the light receiver side and can be received after transmission by means of one or more light receivers, wherein the sensor device is further provided and designed to detect a color of the liquid.

### CROSS-REFERENCE TO RELATED APPLICATIONS

This patent application claims the benefit of and priority to German Patent Application No. 102023117402.9, filed on Jun. 30, 2023, which is herein incorporated by reference in its entirety.

### FIELD OF THE DISCLOSURE

The present invention relates to a household appliance with a sensor device, wherein the sensor device is designed and intended to obtain information about the chemical and physical properties of a liquid using the (spectral) measurement data signature.

### SUMMARY

The present invention relates to a household appliance with a sensor device, wherein the sensor device is designed and intended to obtain information about the chemical and physical properties of a liquid using the (spectral) measurement data signature. The measurement data signature can be used, for example, to determine the turbidity of a liquid. The liquid can be a process water or cleaning water, for example, and is located in a tub of the household appliance. The turbidity is caused, for example, by optical scattering due to particles in the liquid and by optical absorption of the individual components of the liquid. The household appliance can be, for example, a dishwasher, a washing machine or another appliance that can contain a liquid. The sensor device comprises a light transmitter side and a light receiver side, whereby light can be transmitted between the light transmitter side and the light receiver side and through the liquid, which is at least partially located between the light transmitter side and the light receiver side. The light transmitted along the measuring path can be received at the end by means of one or more light receivers.

Such household appliances with sensor devices are sufficiently known from the prior art so that the turbidity of a corresponding liquid can be recognised by means of this sensor device in order to be able to detect a degree of contamination of the cleaning water.

However, according to the state of the art (i.e., a household appliance with a sensor device for detecting the turbidity of a cleaning water), it is not possible to draw conclusions about the color of the cleaning water.

Accordingly, it is the task of the present invention to provide a household appliance with the sensor device, wherein the sensor device is provided and designed to detect a color of the cleaning water.

This task is solved by a household appliance with the features of claim 1 and a method for determining a color of a liquid, with the features of claim 20.

The core idea of the present invention is to provide a household appliance with a sensor device, wherein the sensor device is designed and intended to detect a turbidity of a liquid, for example a cleaning water. The sensor device comprises a light transmitter side and a light receiver side, wherein light can be transmitted from the light transmitter side to the light receiver side and can be received after transmission by means of a light receiver. According to the invention, it is now provided that the sensor device is further provided and designed to detect a color of the cleaning water.

Alternatively or cumulatively, it is conceivable that the optical absorption or transmission and/or the optical scattering by the liquid can be recognised by means of the sensor device.

The color can be used to draw conclusions about the composition of the medium, as different sensor signals can be expected depending on the composition. For example, the components of the liquid medium could be identified by their color and determined both qualitatively and quantitatively. Components of the liquid medium could, for example, be different types of dirt, detergents or coloring agents.

Since the sensor device is also designed to detect the color of the liquid, it can react accordingly when a color change of the liquid is detected. The sensor signals can be connected to a control unit, with which it is possible for the household appliance to carry out specific actions depending on the measurement results or to control the operation of the household appliance. Such actions can be, for example, error messages, acoustic signals, adjusting the washing programme or communication with the smartphone via a wireless connection.

For example, it is possible here for a person to prevent the laundry to be cleaned in a washing machine from being discolored by the color in the liquid that has been released from textiles, for example, by receiving a message on a mobile device.

According to a particularly preferred embodiment, it may be provided that the sensor device comprises one or more light sources. Particularly preferably, the one or more light sources are arranged light transmitter sidedly (i.e., on the light transmitter side). Further preferably, at least two of the primary colors (i.e., red, green or blue) of the additive color mixing can be emitted by the one or more light sources. By attenuating the emitted light of the primary colors red, green or blue through the liquid, the corresponding color of the liquid can be determined. The light source can be formed from several individual light sources, which represent separate light sources. The light source can preferably be from the following group: an LED, a laser, a superluminescent LED, a thermal emitter, or any combination thereof, which can preferably emit at least two of the primary colors red, green and blue, possibly each with a specific wavelength. It is particularly preferred that the one or more light sources can emit three of the primary colors. The at least two, preferably three, of the primary colors can be used to display each color in the additive color space.

According to a particularly preferred embodiment, it is provided that at least two colors, preferably three colors, of visible light (390 nm to 790 nm) can be emitted by means of the one or more light sources. It is particularly preferred that the colors are different from each other in order to cover the additive color space. Purely by way of example, the color red can be emitted with a peak wavelength from a range of 625 nm to 635 nm, the color green with a peak wavelength from a range of 510 nm to 540 nm and the color blue with a peak wavelength from a range of 450 nm to 480 nm. Particularly preferred are the peak wavelengths for red at 630 nm, for green at 520 nm and for blue at 465 nm.

According to a further preferred embodiment, it may be provided that at least one further light source is provided, that is, one or more further light sources. UV light and/or infrared (IR) light can be emitted by means of the further light source(s). This makes it possible to obtain additional information, such as scattering and the like on particles or fluorescence, from the interaction of UV or IR light with the liquid.

It is also conceivable to provide broadband light sources in the sensor device, such as LEDs that emit white light. If, for example, three colors are emitted by the light source or light sources, peak wavelengths in the range 400-500 nm are conceivable for a first color, peak wavelengths in the range 500-600 nm for a second color and peak wavelengths in the range 600-700 nm for a third color in the preferred embodiment. The colors can form a color triangle in the color diagram. The spectrum of the light from colored light sources in the visible range is typically subject to a Gaussian or Lorentz distribution around a peak wavelength. UV and IR light sources usually also have a Gaussian or Lorentz distribution around a peak wavelength.

According to a preferred embodiment, it may be provided that the sensor device has a light guide. A light guide can be used to transmit light in a simple and cost-effective manner. In a further preferred embodiment, it may be provided that the light guide is divided into the light transmitter side and the light receiver side. Accordingly, the light transmitter side and the light receiver side can be simply formed by the light guide.

Alternatively, it is conceivable that the sensor device does not comprise a light guide, so that direct transmission of light from the light transmitter side to the light receiver side is provided.

It is particularly preferable that the light transmitter side and the light receiver side are arranged at a distance from each other. This means that the light source(s) and the light receiver(s) are at a distance from each other, with the distance being greater than zero.

Further preferably, the one or more light sources are arranged on the light transmitter side. Preferably, the one or more light receivers are arranged on the light receiver side.

The colors are emitted by the one or more light sources, transmitted by means of the light guide from the light transmitter side through the liquid to the light receiver side and transmitted accordingly to the light receiver. In order to avoid mixing with regard to the absorption rate when passing through the liquid, a particularly preferred embodiment provides for the colors to be emitted one after the other in a specific or determinable order by means of the light source(s). This means, for example, that first the first color, for example red, then the second color, for example green, and finally the third color, for example blue, are emitted by the light source and corresponding signals are recorded.

According to a further preferred embodiment, it is provided that after a color has been emitted by the light transmitter, the light can be received and a corresponding sensor signal can be obtained.

According to a preferred embodiment, it can be provided that different wavelength ranges can be received one after the other in a certain order by means of one or more light receivers. This allows the individual wavelengths to be analysed or assigned one after the other.

The sensor signal is particularly preferably dependent on the color of the liquid. For example, if the liquid is dyed in a color that has dyed clothing, the light of one color is absorbed better than the light of another color. For example, if the liquid is colored red, blue and green light is absorbed more strongly than red light, which is hardly absorbed at all. In the case of an orange or yellow liquid, for example, blue is absorbed most strongly, while green is absorbed only slightly and red hardly at all.

The corresponding sensor signal of the light receiver is therefore dependent on the color of the cleaning water, so that conclusions can be drawn about the actual color.

It is particularly preferred that the one or more light receivers is at least one selected from the group comprising a phototransistor, a photodiode, a bolometer, and any combination thereof. In principle, a laser diode would also be conceivable. With the help of the light receiver, for example a phototransistor, the respective light can be detected and a corresponding signal can be output to the system. With a phototransistor, a photocurrent is generated by the received light; the more light is received, the greater the photocurrent. The photocurrent can be tapped at the phototransistor using a suitable circuit and converted into another signal, such as a voltage. Similarly, a suitable output signal is also generated for the other types of receiver. Other receivers that can be used are consecutive sensors or active layers, for example phototransistors with different band gaps in the active zones. In addition, 1-pixel or multi-pixel RGB cameras can be used as receivers.

It is particularly preferable to use phototransistors, photodiodes, bolometers, laser diodes or any combination of these as light receivers. Along the measurement path, the light emitted by the transmitter is attenuated or weakened and detected at the end of the measurement path by the receiver (e.g., a phototransistor). The received light is then converted into an electrical signal, such as a voltage. The value of the output signal depends on the attenuation of the light by the measuring path.

Depending on the wavelength of the emitted light, it is attenuated to different degrees along the measuring path by the media through which it passes. Different output signals, for example in the form of an electrical voltage, can therefore be expected for different wavelengths. The resulting output signals can be used to infer the color of the liquid within the measuring section.

It is further preferred that the sensor signal, for example a voltage, can be recorded separately for each color of the light received by the transmitter or transmitters, such as the first, second and third color, for example in the form of red, green and blue, at the light receiver or light receivers. The corresponding or respective sensor signals can then be combined, for example by means of a control unit, in order to determine the color of the liquid in the additive color space.

Preferably, broadband receivers that can receive light in a wide wavelength range can be used. Furthermore, the receivers can be equipped with a short-pass or long-pass filter or a band-pass filter, for example. The light sources could also be equipped with wavelength filters. However, these filters could also be realised as a separate component, for example on the transmitter and/or receiver side. The filters can also be arranged as a separate component in the form of a switchable, segmented filter wheel, so that different wavelength ranges can be set for each segment, which can be filtered out. Such a filter wheel could be used on both the transmitter and receiver side. A filter wheel could have different segments that filter out different wavelength ranges. Alternatively, the filters could be switchable glass whose transmission can be varied in certain wavelength ranges by applying an electrical voltage or a temperature. Such glass can be electrochromic or thermochromic. It can also be LC glass, the function of which is similar to an LC display. Furthermore, several receivers can also be arranged as a detector array.

According to a particularly preferred embodiment, it is provided that the sensor device is calibrated or can be calibrated. In particular, the calibration refers to an uncolored and clear or transparent liquid (i.e., tap water or distilled water, for example). This means that when the light is sent from the light transmitter side to the light receiver side or from the light source(s) to the light receiver(s), the sensor signal of the light receiver(s) can be assigned to an uncolored liquid, for example the cleaning liquid. The fact that one or more light components are absorbed due to the discoloration of the liquid also changes the output signal of the sensor, for example the voltage that is output when the light is detected.

The color in the additive color space can be represented and determined as shown below.

As the light or the colors of the light such as red, green, blue are absorbed or partially absorbed by the liquid, the sensor output signal, which can be, for example, a voltage, a current, a PWM, or the like, and any combination thereof, changes accordingly. This relationship applies to light of any wavelength, including in the applicable range between 200 nm and 2500 nm.

It can be understood that the calibration is or corresponds to the value 100%, so that an absorbed light color then accounts for a correspondingly lower percentage. This percentage can be multiplied by the color factor of the additive color space of 255. The value 255 corresponds to the maximum value of the color for the respective color. If the percentage determined is multiplied by the color space value 255, a corresponding value is produced in the additive color space for each of the colors present. The combination of the values determined in the color space for red, green and blue then gives the three intensities in the additive color space, which can be used to determine the color in which the liquid is present.

Alternatively, color space values can also be specified on a scale as percentage values with values from 0 to 100% and/or as a factor with values from 0 to 1 or in other units and, if necessary, linear and non-linear scaling thereof. The calculation of the color space values using the sensor signals is carried out analogously each time.

Furthermore, according to a particularly preferred embodiment, it is provided that in particular an additional emission of an infrared light or a light in the infrared range is provided. This allows the turbidity of the cleaning water to be checked, in particular assuming low optical absorption in the liquid in the IR spectrum. Since the intensity of the respective colors red, green and blue can also be reduced by reflections or scattering from dirt particles or the like if the cleaning water is relatively cloudy or very cloudy, it is intended to display the colors as a function of the turbidity of the cleaning water. This makes it possible to determine whether a color has been absorbed due to the turbidity of the cleaning liquid or due to the color of the cleaning liquid.

It is known that optical scattering can be wavelength-dependent. Shorter wavelengths are often more strongly influenced non-linearly by scattering than longer wavelengths. This applies both globally over the visible range and over the range of broadened emission of the individual light sources. This non-linearity changes the detected peak of the emission and the light spectrum and shifts it towards longer wavelengths. This can be compensated for by a representative measurement of the scattering in the selected absorption-free IR range, for example using software.

Furthermore, according to a particularly preferred embodiment, it is possible that the cleaning liquid or the cleaning water is already pre-colored by a detergent or the like. In order to recognise that the coloring of the cleaning water is due to the detergent and not due to a loss of dye from, for example, clothing, it may be possible to take the color of the detergent into account in the present control unit. Changes in the color of the liquid, which already has the color of the detergent, is still possible by means of the present invention.

Furthermore, according to a preferred embodiment, it may be provided that the control unit can be sent a notification to an application or the like, for example on a smartphone, when a discoloration or coloring of the cleaning water that is undesirable is detected. In this way, the respective user of the household appliance can be informed that the objects to be cleaned, for example the laundry, are expected to be discolored and that the washing process should therefore be cancelled.

Accordingly, according to a further preferred embodiment, it can be provided that if discoloration of the cleaning water is detected, the household appliance can be stopped automatically by a corresponding control signal from the control unit, so that further discoloration of the object to be cleaned can also be avoided.

It is also possible to use the coloring of the cleaning water to monitor various treatment processes, for example in the textile industry. Here it would be advantageous for the wastewater produced during the dyeing process to be discharged into the environment without the respective residue of the dye.

According to a preferred embodiment, it is also conceivable that the calibration is not carried out with regard to an uncolored and transparent water, but also, for example, with regard to a frequently used cleaning water with one or more specific detergent additives. This can, for example, be stored as a calibration so that the influence of the detergent can be minimised.

According to a further preferred embodiment, it may be provided that the sensor device comprises a memory unit. For example, the various detergent additives, calibration settings and the like can be stored in the memory unit and changed, added or deleted as required. Accordingly, a corresponding set corresponding to the actual use of the household appliance can then be called up for each washing process.

According to a further preferred embodiment, it may be provided that the sensor device is connected to a database, for example via Internet/LAN, and can communicate with it in both directions. In the database, for example, measured variables or determined parameters can be stored, for example for different detergent additions, calibration settings and the like, and can be changed, added or deleted as required. Accordingly, a corresponding record can then be called up for each washing process, which corresponds to the actual use of the household appliance. Furthermore, updates can be obtained via the database.

According to another preferred embodiment, the (spectral) measurement data signature can be analysed using artificial intelligence (AI). The AI can help to characterise a liquid with regard to its chemical and physical properties.

According to another preferred embodiment, it is envisaged that exactly one light receiver is provided, for example in the form of a phototransistor. This means that the sensor device can comprise exactly one phototransistor. This makes it possible to further reduce the number of components required. Accordingly, the sensor device is therefore configured in such a way that the different colors of the light source are deflected in such a way that they can irradiate the phototransistor. For this purpose, a light deflecting structure or a light guide element, for example a (totally reflecting) deflecting mirror, is provided, which is designed in such a way that the various light beams are concentrated on as small an area as possible or ideally or preferably focussed at a point where the phototransistor is located.

According to a particularly preferred embodiment, the sensor device has a light guide element, whereby the light guide element is intended and designed to deflect light in such a way that it is focussed on a single point or near the single point. The light receiver is preferably arranged at this point.

If, for example, several light sources are provided as separate components, the respective beam paths can be combined accordingly and better detected by the light receiver.

According to a further preferred embodiment, the light guide element may be a parabolic element or a curved surface. This allows the light to be deflected and focussed into a single point.

The light guide element is also preferably arranged on the light guide in the vicinity of the light receiver.

According to a further preferred embodiment, it may be provided that the sensor device comprises a housing. It is particularly preferred that the electronic components, such as the light receiver, light source(s) and light guide are arranged within the housing. It is further preferred that the housing is at least partially translucent. The housing is also preferably designed in such a way that it is sealed against the liquid.

The underlying task is also solved by a method for determining the color of a liquid, the method comprising the following steps: a) providing a household appliance according to a preferred embodiment; b) emitting light by means of the light source or a plurality of light sources; c) receiving the light by means of the light receiver or a plurality of light receivers and obtaining a sensor signal; d) combining the sensor signals and determining a color of the liquid.

Further embodiments and configurations of the embodiments can be applied to the other embodiments and can be freely combined with one another, provided that they do not correspond to opposing embodiments. Further advantageous embodiments are shown in the subclaims.

The features relating to the structural configuration and the process features can be used in a corresponding manner. Likewise, features which are disclosed only in combination with further features can also be regarded as disclosed independently of these features.

### BRIEF DESCRIPTION OF THE DRAWINGS

The invention is described in more detail below in connection with the figures.

Further objectives, advantages and usefulness of the present invention can be found in the following description in conjunction with the figures and drawings. Herein show:

FIG. 1 a household appliance with sensor device;

FIG. 2A a schematic representation of the sensor device according to one embodiment;

FIG. 2B a schematic illustration of the sensor device according to another embodiment;

FIG. 3 a circuit of the sensor device according to one embodiment;

FIG. 4 a wavelength spectrum;

FIG. 5A a photograph of samples;

FIG. 5B a table of samples;

FIG. 6A a sensor device with light guide element;

FIG. 6B a sensor device with light guide element;

FIGS. 7A-7D sensor devices according to the embodiments of FIGS. 6A and 6B; and

FIG. 8 a process sequence for determining the color of the cleaning water.

### DETAILED DESCRIPTION

In the figures, identical components are to be understood with the corresponding reference signs. For the sake of clarity, some components in some figures may not be labelled with a reference sign but have been designated elsewhere.

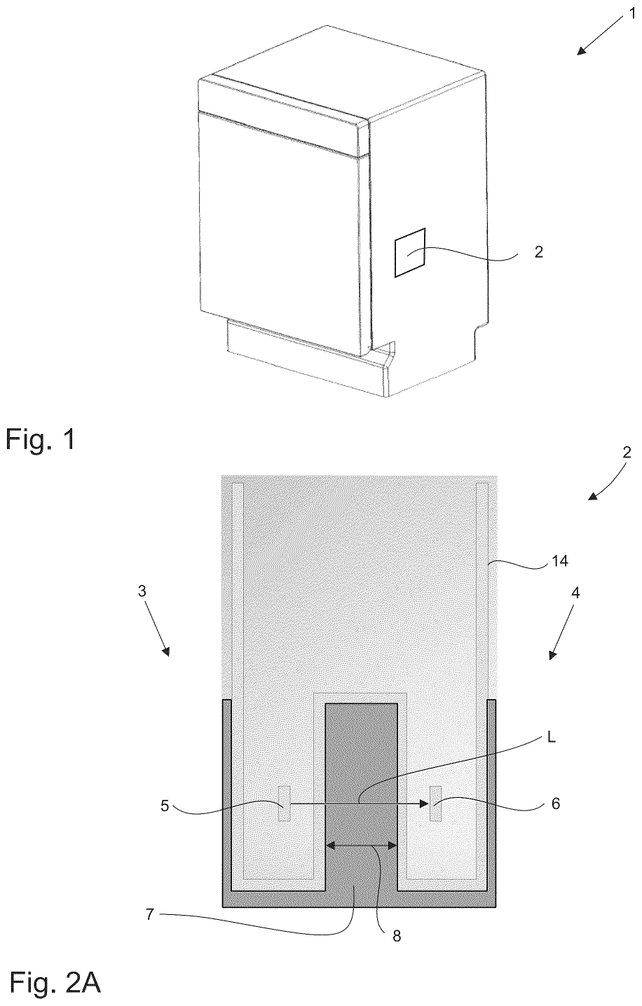

According to FIG. 1, a household appliance 1 is shown schematically, which can be designed, for example, as a dishwasher, a washing machine or the like. The household appliance 1 comprises a sensor device 2, which is integrated in the household appliance 1. It is preferably provided that the sensor device 2 is at least partially in contact with a liquid 7, for example a cleaning water 7. A control unit 17 is also shown, to which the sensor signals can preferably be connected. By means of the control unit 17, it may be possible for the household appliance 1 to carry out actions depending on the measurement results or sensor signals or to control the operation of the household appliance 1. Such actions can be, for example, error messages, acoustic signals, adjustment of the washing programme or communication with the smartphone via a wireless connection, such as WLAN, Bluetooth or similar.

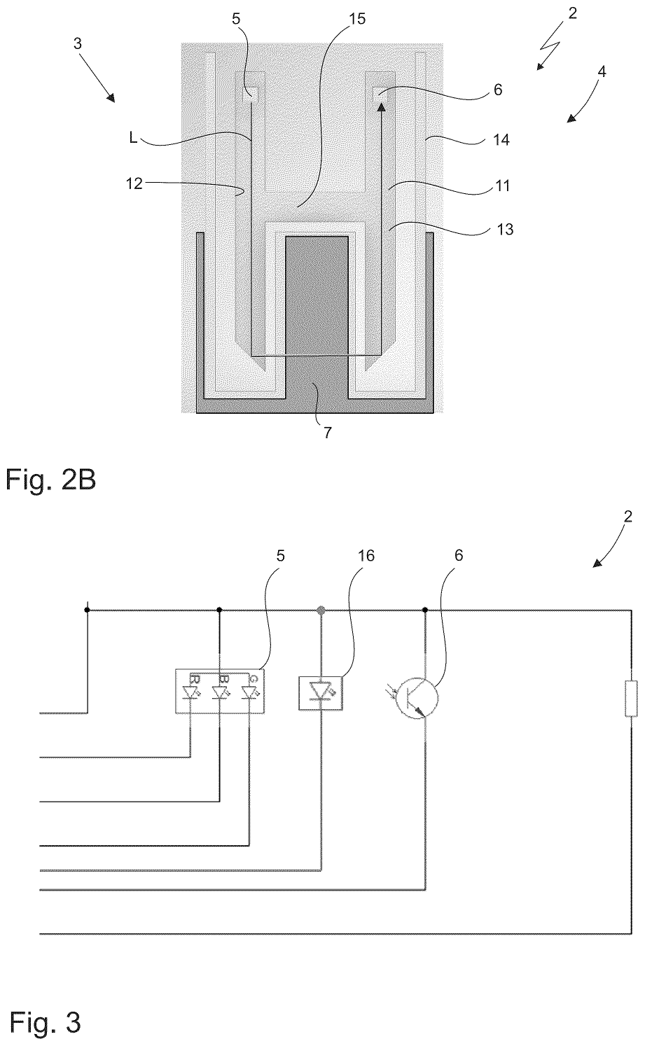

FIGS. 2A and 2B show the sensor device 2 in more detail according to two embodiments, whereby certain components are already present, as the sensor device 2 is based on a turbidity sensor, so that additions to the present sensor device 2 are considered necessary. Regardless of the embodiment, the sensor device 2 has a light transmitter side 3 and a light receiver side 4. At least one light source 5 and at least one light receiver 6 are also provided. Light can be emitted by means of the light source 5. For example, the light source 5 is an LED light source that can emit light with a specific wavelength or light with specific wavelengths.

According to FIG. 2A, a section of the sensor device 2 is shown, wherein one or more light sources 5 are arranged on the light transmitter side 3 and one or more light receivers 6 are arranged on the light receiver side. Light can be emitted by means of the light source(s) 5 and received by means of the light receiver(s) 6. As an example, the light is shown as a light path L between light source 5 and light receiver 6.

Further preferably, the light transmitter side 3 and the light receiver side 4 are arranged at a distance from each other (i.e., at a distance 8 from each other). The sides 3 and 4 are particularly preferably finger-shaped. A liquid 7 is provided between the light transmitter side 3 and the light receiver side 4, so that the emitted light passes from the light transmitter side 3 to the light receiver side 4 through the liquid 7.

Furthermore, a housing 14 is provided in which the electronic components are located in order to seal them off from the liquid 7.

FIG. 2B shows a further or more advanced embodiment of the sensor device 2.

Preferably, the sensor device 2 comprises a light source 5 on the light transmitter side 3. The sensor device 2 has a light guide 11 with a first light guide element 12 and a second light guide element 13. Preferably, the first light guide element 12 is arranged on the light transmitter side 3 and the second light guide element 13 is arranged on the light receiver side 4. Preferably, the light guide elements 12, 13 can be connected to each other, for example by means of a connecting element 15. This can increase the stability of the light guide 11. The designs and embodiments of FIG. 2A also apply to FIG. 2B.

The light, represented by the light path L, of the light source 5 is emitted to the first light guide element 12, transported by means of the first light guide element 12 and transmitted to a second light guide element 13. It is particularly preferable for the light guide elements 12, 13 to be spaced apart from one another by a distance 8. When the light is guided in the second light guide element 4, the light is transmitted to one or more light receivers 6, the light receiver 6 being designed to receive the light and output a corresponding sensor signal. When the light is transmitted from the first light guide element 12 to the second light guide element 13, the light passes through the liquid 7.

Since the light guides 12, 13 may already be present, the light source 5 and the light receiver 6 are arranged at a distance from the respective light guide elements 12, 13. In existing turbidity sensors, the existing standard turbidity sensor design can be used, for example by providing a multi-chip LED that can emit the colors red, green and blue and/or white. In this way, the functionality for detecting one of the colors of the liquid 7 can be subsequently integrated into the existing turbidity sensor.

It may also be provided that the light receiver 6 and the light source 5 can be connected to each other, at least by signalling, so that a change or deviation of the received sensor signal of the light receiver 6 is compared as a function of the reference value present in the light source 5.

It is particularly preferable that the light arriving at the light receiver 6 is converted into an electrical variable, for example a voltage, using a suitable circuit, whereby the electrical variable, for example the voltage, can represent the output signal. If a reference liquid is present between the light sides 3, 4 during measurement, the output signal, for example a voltage, can be taken as the reference value for the reference state. Any deviation from the reference state produces a different measurement result or a different output signal, such as a voltage. Based on the absorption or attenuation of light or certain wavelengths of light, the color of the liquid 7 can then be inferred.

The sensor signal is dependent on the intensity or a non-absorbed part of the transmitted light.

It is particularly preferable that the light receiver 6 is designed as a phototransistor. The phototransistor is sensitive to the transmitted light, whereby when light strikes the phototransistor, a photocurrent is generated by the photoelectric effect, which can be further processed into an output signal using a suitable electrical circuit. The output signal can be a voltage, for example, which is consequently dependent on the intensity of the light arriving at the receiver.

An exemplary section of the wiring of the present light source 5 and the light receiver 6 is shown in FIG. 3. One or more additional light sources 16 can also be provided, which can emit UV light and/or IR light, for example. In principle, depending on the design of the sensor device 2, the circuit can be adapted accordingly.

The sensor device 2 can preferably be calibrated accordingly, whereby a calibration can be carried out with regard to a reference liquid, for example. Particularly preferably, the reference liquid can be clear water or distilled water, so that the received light can be indicated as the reference by means of the light receiver 6 and the corresponding sensor signal. If the emitted light is attenuated along the measurement path, the output signal changes depending on this attenuation. The deviation from the reference signal can be used to draw conclusions about the properties of the liquid, such as its color.

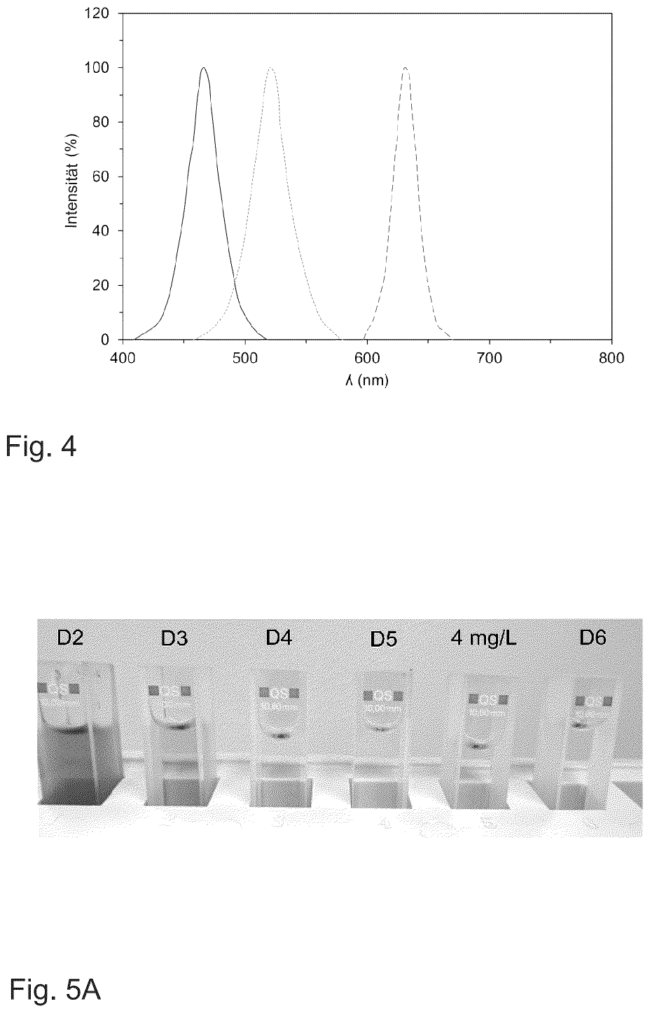

FIG. 4 shows an example of the colors that can be emitted by the one or more light sources 5. As also shown in FIG. 3, the light source 5 is intended to emit at least three different colors, with the emitted colors preferably being the primary colors red, green and blue of additive color mixing. According to FIG. 4, it is further provided where the respective wavelength ranges or the corresponding peak wavelength of the respective range can be located.

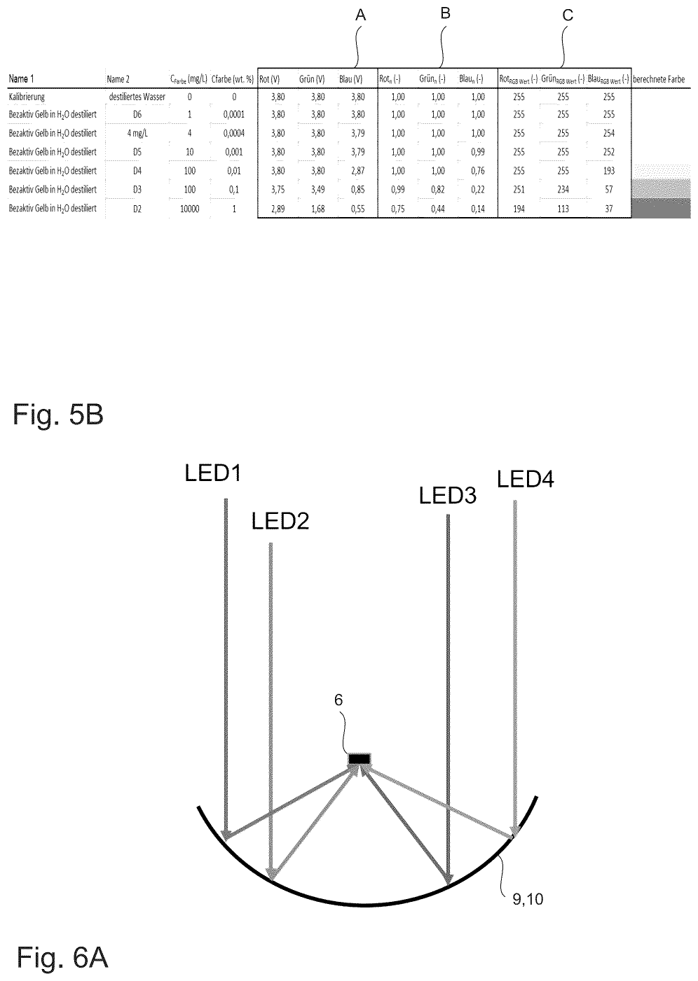

FIGS. 5A and 5B show a sample series with the corresponding evaluation and how the color of the liquid 7 can be determined by the sensor device 2.

The present system with the sensor device 2 is calibrated or referenced to distilled water. Further samples are indicated here, which are numbered or labelled accordingly. The color differences can be clearly seen in FIG. 5A. The values output by the light receiver 6 with regard to the transmitted colors red, green and blue are accordingly highlighted as 100%. Deviations in the output of the light receiver 6 (i.e., the phototransistor) are indicated accordingly in lower percentages. This can be seen, for example, in samples D3 and D2. It can also be seen which of the colors red, green and blue are absorbed accordingly.

After determining or obtaining the respective sensor values, these values are multiplied by the maximum value of the additive color space, whereby this value is 255. The value obtained (i.e., the multiplied value of the 255 value times the respective percentage) gives the respective value in the additive color space. This is done with each of the colors red, green and blue, so that the respective hue of the additive color space can be determined by combining the three multiplication values. As can be seen from the comparison of the colors in FIGS. 5A and 5B, the calculation or determination is very accurate.

Section A of FIG. 5B shows the respective measured values and the reference value. Section B of FIG. 5B shows the ratio of the respective measured value to the reference value.

Finally, section C shows the respective calculated value of the additive color space, which can be used to determine the color in the additive color space.

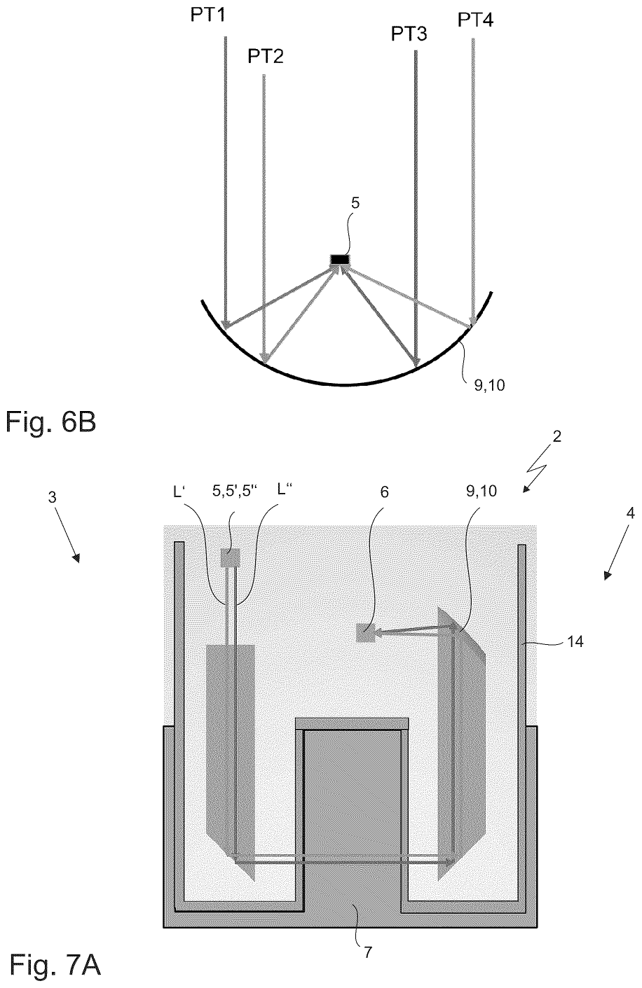

According to a preferred embodiment, it is intended that a single light receiver 6 should be provided. In order to be able to focus different light beams or several light paths onto the single light receiver element 6, it is preferably provided that a light guide element 9 is provided, wherein the light guide element 9 is provided and designed to deflect light in such a way that it is focussed into a single point. Particularly preferably, this light guide element 9 is shown in FIG. 6A, wherein light guide element 9 is a parabolic element or curved surface 10. The designations LED1 to LED4 are shown for different outputs or light emissions of the light source 5, which can correspond, for example, to the colors red, green, blue and an infrared light source.

Conversely, according to one embodiment, as shown in FIG. 6B, it would be possible for a single light source 5 to be provided, for example as a broadband light source, such as a white-colored LED, which is divided by means of the light guide element 9 or the parabolic element 10. The phototransistors are preferably designed in such a way that they are only sensitive to a certain wavelength range or that filters are arranged corresponding to the light guide element 9 and the phototransistor, which can filter the light of the light source 5. Preferably, the filters can also be arranged in the respective light receiver.

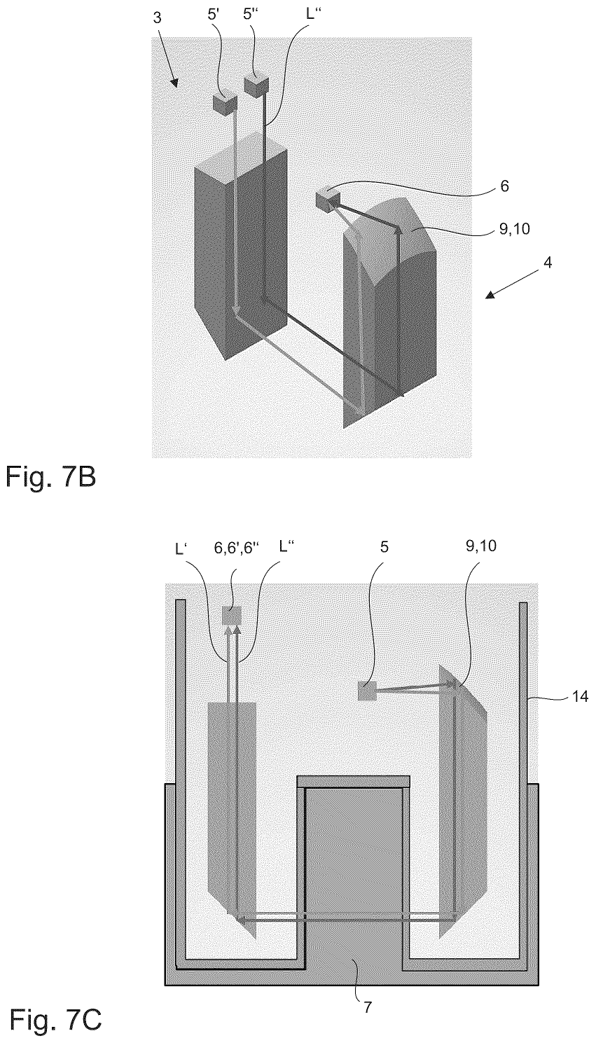

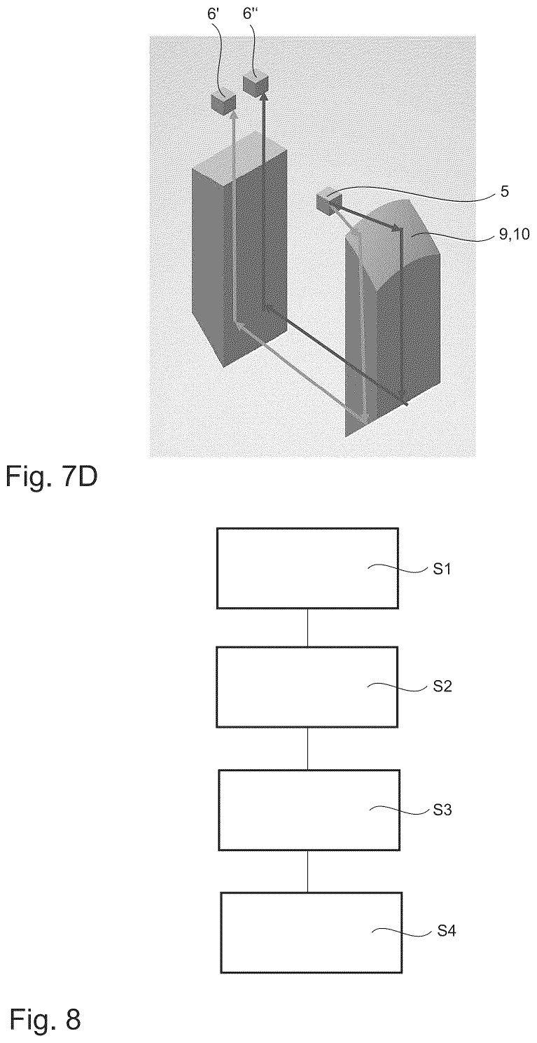

By way of example only, a sensor device 2 with the light guide element 10 is shown in FIGS. 7A to 7D. FIGS. 7A and 7B show several light sources 5 with a single light receiver 6. In FIGS. 7C and 7D, several light receivers 6 are shown with a single light source 5.

FIGS. 7A and 7B show at least two light sources 5, 5′, 5″, each of which is assigned to a first or second light path L′, L″. The transmission of the light from the light source 5, 5′, 5″ to the light receiver 6 has already been illustrated. The light guide element 9 is now additionally arranged in front of the light receiver 6, which focusses the light paths L′, L″ on a point at which the light receiver 6 is arranged.

FIGS. 7C and 7D show the other case, with a single light source 5 and several light receivers 6, 6′, 6″.

FIG. 8 shows a purely exemplary method for determining the color of the cleaning water 7, whereby the method comprises the following steps:

In step S1, a corresponding household appliance 1 is provided, which comprises the sensor device 2 according to the invention. In the next step S2, light is emitted by means of the light source 5 and preferably transmitted to the light receiver 6 via the light guides 3, 4. In step S3, the light is received by means of the light receiver 6 and a corresponding sensor signal is obtained from the light receiver 6. After receiving the respective sensor signal, for example for the different colors of the light source 5, these sensor signals are combined with each other and the color of the cleaning water 7 is determined from the combination of the sensor signals.

The applicant reserves the right to claim all the features disclosed in the application documents as being essential to the invention, provided that they are new compared to the prior art, either individually or in combination. It should also be noted that the individual figures also describe features which may be advantageous in themselves. The skilled person immediately recognizes that a particular feature described in a figure can also be advantageous without the adoption of further features from this figure. Furthermore, the skilled person recognizes that advantages can also result from a combination of several features shown in individual figures or in different figures.

### LIST OF REFERENCE SIGNS

1 Household appliance
2 Sensor device
3 Light transmitter side
4 Light receiver side
5,5′, 5″ Light source
6, 6, 6″ Light receiver
7 Liquid, cleaning water
8 Distance
9 Light guide element
10 Parabolic element
11 Light guide
12 First light guide element
13 Second light guide element
14 Housing
15 Connecting element
16 Further light source
17 Control unit
L, L′, L″ Light path

What is claimed is:

1. A household appliance with a sensor device, wherein information about chemical and/or physical properties of a liquid is determined on a basis of a spectral measurement data signature, wherein the sensor device has a light transmitter side and a light receiver side, wherein light is transmitted from the light transmitter side to the light receiver side and is received after transmission via one or more light receivers, characterized in that the sensor device is configured to detect a color of the liquid.

2. The household appliance according to claim 1, wherein the information about chemical and/or physical properties of the liquid comprises a turbidity of the liquid.

3. The household appliance according to claim 1, characterized in that the sensor device has one or more light sources on the light transmitter side, wherein at least two primary colors of an additive color mixing are emitted by the one or more light sources.

4. The household appliance according to claim 3, characterized in that the one or more light sources are configured to emit three primary colors.

5. The household appliance according to claim 3, characterized in that the at least two primary colors of the additive color mixing are emitted one after the other in a certain order via the one or more light sources.

6. The household appliance according to claim 3, characterized in that after at least one of the at least two primary colors has been emitted, the light is received via the one or more light receivers, and a corresponding sensor signal is obtained, the corresponding sensor signal being dependent on the color of the liquid.

7. The household appliance according to claim 6, characterized in that the one or more light receivers comprise a phototransistor, a photodiode, a laser diode, a bolometer, or any combination thereof, such that the corresponding sensor signal comprises a voltage, a current, a pulse width modulation, or any combination thereof, wherein the corresponding sensor signal is recordable for each color and said respectively corresponding sensor signals are combinable to determine the color of the liquid in an additive color space.

8. The household appliance according to claim 1, characterized in that the sensor device has one or more light sources via which a broadband spectrum is emitted.

9. The household appliance according to claim 1, characterized in that at least one further light source is provided, via which infrared and/or ultraviolet light are emitted.

10. The household appliance according to claim 9, characterized in that the at least one further light source comprises a light-emitting diode (LED), a laser, a superluminescent LED, or any combination thereof.

11. The household appliance according to claim 1, characterized in that different wavelength ranges are received one after the other in a specific sequence via the one or more light receivers.

12. The household appliance according to claim 1, characterized in that the sensor device comprises a light guide which is divided into the light transmitter side and the light receiver side.

13. The household appliance according to claim 12, characterized in that the light guide comprises a first light guide element and a second light guide element, wherein the light transmitter side is provided by the first light guide element and the light receiver side is provided by the second light guide element.

14. The household appliance according to claim 12, characterized in that the light guide has a light guide element, the light guide element being configured to deflect light in such a way that said light is focused into a single point, a single light receiver being provided in the single point.

15. The household appliance according to claim 14, characterized in that the light guide element is a parabolic element and/or a curved surface.

16. The household appliance according to claim 12, characterized in that the light guide has a light guide element, wherein the light guide element is configured to split light with a broadband spectrum into a plurality of individual light beams.

17. The household appliance according to claim 16, characterized in that a single light receiver is provided, which is configured to receive the broadband spectrum.

18. The household appliance according to claim 16, characterized in that a plurality of light receivers are provided, which are configured to receive the plurality of individual light beams.

19. The household appliance according to claim 18, characterized in that each of the plurality of light receivers has a different spectral sensitivity, so that each of the plurality of light receivers receives light of a different color.

20. The household appliance according to claim 18, characterized in that one or more optical filter elements are arranged between the plurality of light receivers and the light guide element, which are configured to filter the light optically.

21. The household appliance according to claim 1, characterized in that the light transmitter side and the light receiver side are arranged at a distance from one another.

22. The household appliance according to claim 1, characterized in that the spectral measurement data signature is able to be evaluated with the aid of artificial intelligence.

23. The household appliance according to claim 22, wherein the spectral measurement data signature is so evaluated with regard to characterization of the liquid in chemical and physical properties thereof.

24. A method for determining a color of a cleaning water, the method comprising:
providing a household appliance according to claim 1;
emitting light by means of a light source;
receiving the light by means of the one or more light receivers and obtaining one or more sensor signals; and
combining the one or more sensor signals and determining a color of the liquid.
